(19) United States
(12) Patent Application Publication
(10) Pub. No.: US 2009/0287648 A1
(43) Pub. Date: Nov. 19, 2009

(54) Ad-based revenue generation using media-hashing to control fraud

(75) Inventor: Yacov Yacobi, Mercer Island, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/152,417

(22) Filed: May 14, 2008

(51) Int. Cl. H04L 9/00; G06F 17/30

(52) U.S. Cl. 707/3; 705/52; 707/E17.032

(57) ABSTRACT

The claimed subject matter provides systems and methods that controls fraud and/or generates revenue. The system can upload media content to a generator that produces a digital certificate that includes a short identifier associated with the content. The system further sends the media content together with the digital certificate associated with the media content to a server that forwards the short identifier to a database engine which in return supplies the server with details associated with the producer of the content. At the request of a playback device the server can download the content to the playback device, at which point the playback device notifies the server to effectuate payment for utilization of the downloaded content by the playback device.

### BACKGROUND

As computing and network technologies have evolved and have become more robust, secure and reliable, more consumers, wholesalers, retailers, entrepreneurs, educational institutions, and the like have and are shifting business paradigms and are employing such technologies to perform business rather than utilizing traditional means. For example, today many television broadcasting services and systems can utilize networking and computing technologies to not only produce and create television shows, but also to disseminate such multimedia content to users situated on many broadcast media. Nevertheless, these multimedia companies are now struggling to reclaim control over their movies, television shows, and music in a world of on-line sharing software. For example, many songs and videos are being posted on the Internet without permission. Further, it is not difficult to find dispersed throughout the Internet sites where the latest movies and/or music clips can be downloaded, viewed or listened to without the artists, owners, or producers ever being compensated for the use of such material. Moreover, many file sharing sites that wish and desire to legitimately recompense artists, owners, and/or producers of multimedia content can find it difficult or impossible to discern between copyrighted material uploaded in breach of copyright and material that has no known copyright attribution and thus can legitimately be shared and disseminated amongst a countless number of individuals.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

The claimed subject matter in accordance with an aspect provides systems and methods that generate revenue or control fraud by employing media hashing functions. The system as disclosed herein can upload content to a generator that utilizes a media hashing function to produce a digital certificate that includes a short identifier associated with the uploaded content. The system thereafter can direct the content together with the generated digital certificate to a server that forwards the short identifier to a database engine which supplies the server with details associated with the producer of the content. At the request of a playback device the server downloads the content to the playback device, at which point the playback device notifies the server to effectuate payment for utilization of the downloaded content by the playback device.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that generates revenue or controls fraud by employing a media hashing function in accordance with the claimed subject matter.

FIG. 2 provides a more detailed depiction of an illustrative content producer that generates revenue or controls fraud in accordance with an aspect of the claimed subject matter.

FIG. 3 provides a more detailed depiction of an illustrative certificate authority that generates revenue or controls fraud in accordance with an aspect of the claimed subject matter.

FIG. 4 provides a more detailed depiction of web hosting server that generates revenue or controls fraud in accordance with an aspect of the claimed subject matter.

FIG. 5 provides a more detailed depiction of an illustrative database engine that generates revenue or controls fraud in accordance with an aspect of the claimed subject matter.

FIG. 6 provides a further depiction of a machine implemented client device that generates revenue or controls fraud in accordance with an aspect of the subject matter as claimed.

FIG. 7 provides depiction of an illustrative transaction diagram utilization of which generates revenue or controls fraud in accordance with an aspect of the claimed subject matter.

FIG. 8 provides illustration of a transaction diagram utilization of which generates revenue or controls fraud in accordance with an aspect of the claimed subject matter.

FIG. 9 illustrates a flow diagram of a machine implemented methodology that generates revenue or controls fraud in accordance with an aspect oft the claimed subject mater.

FIG. 10 illustrates a further flow diagram of a machine implemented methodology that generates revenue or controls fraud in accordance with an aspect of the claimed subject matter.

FIG. 11 illustrates a block diagram of a computer operable to execute the disclosed system in accordance with an aspect of the claimed subject matter.

FIG. 12 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

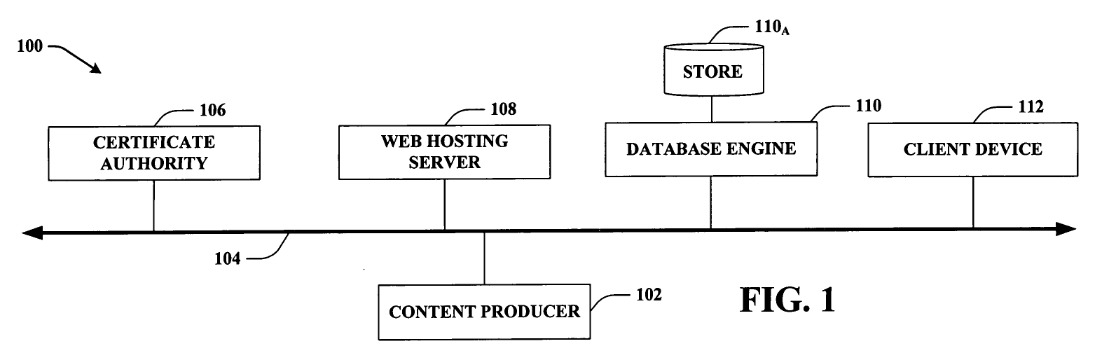

FIG. 1 illustrates a machine implement system 100 that generates revenue or controls fraud by employing a media hash function in accordance with an aspect of the claimed subject matter. System 100 can include content producer 102 that can be a device and/or component that records multimedia audio/visual content to associated persistence media (e.g., volatile and/or nonvolatile memory that can be electronically erased and/or programmed, nonvolatile storage that persists digitally encoded data on rapidly rotating platters with magnetic and/or optically retentive surfaces and/or coatings, and/or magnetic tape) for subsequent playback on client device 112. Content producer 102 can direct produced content or objects to a certificate authority (e.g., certificate authority 106) and request the certificate authority to issue a certificate. Typically, the certificate issued by the certificate authority, in accordance with an aspect of the claimed subject matter, can include a hash of the contents or the object (e.g., through utilization of a media hash function) together with details associated with content producer 102. Once content producer 102 has received an appropriate certificate, it can forward the content or object (e.g., un-hashed content) at issue together with the issued certificate associated with the content to a web server or web service (e.g., web hosting server 108). It should be noted, without limitation, that a distinction can be drawn between “media hash” functions as employed, at least in part, by the claimed subject matter and standard “crypto hash” functions typically utilized in this field of endeavor. In particular, “media hash” functions are generally insensitive to small deformations in its input, whereas “crypto hash” functions are typically extremely sensitive to any or perturbation or deformation in input (e.g., a change of even 1 bit in the input can flip on the average ˜½ the bits in the output).

As illustrated, content producer 102 can be a standalone set-top box, or portable recording and/or playback device. Additionally, content producer 102 can be implemented entirely in hardware and/or a combination of both hardware and/or software. Moreover, content producer 102 can be incorporated within and/or associated with other compatible components. Content producer 102 can be any type of device, facility, and/or instrument of conversion that includes a processor and is capable of effective and/or operative communication with network topology and/or cloud 104. Illustrative mechanisms, machines, devices, facilities, and/or instruments that can comprise content producer 102 can include Tablet PCs, server class computing machines, laptop computers, notebook computers, desktop computers, cell phones, smart phones, consumer appliances and/or instrumentation, industrial devices and/or components, hand-held devices, personal digital assistants, multimedia Internet enabled phones, Global Positioning Systems (GPS), USB flash devices, multimedia players, televisions, and the like.

Network topology and/or cloud 104 can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, network topology and/or cloud 104 can include or encompass communications or interchange utilizing Near-Field Communications (NFC) and/or communications utilizing electrical conductance of the human skin, for example.

Certificate authority 106 can be an entity that issues certificates for use by other parties. In accordance with an aspect of the claimed subject matter, certificate authority 106 can issue a certificate that includes a key and details regarding the owner of the certificate (e.g., content producer). Certificate authority 106 effectively attests that the issued key associated with the issued certificate belongs to the entity noted in the certificate. In order to facilitate its aims, certificate authority 106 can effectuate a search of lists associating hashes of content objects with their respective producers, content enhancers, etc. The lists associating hashes of content objects with respective producers, content enhancers, etc. can be associated with database engine 110 and its affiliated storage devices 110_{A}. Where certificate authority 106 is unable to find a corresponding and/or previously generated hash of content objects with an associated producer, content enhancer, etc., it can utilize content received from content producer 102 together with a media hash function to derive or produce a hash of the content that is a relatively short representation of the supplied content. Once certificate authority 106 has produced the hash of the supplied content it can associate the hash with details affiliated with the content producer 102 to create a certificate that can be sent to content producer 102, as well as forwarded to database engine 110 for storage on storage devices 110_{A} and subsequent utilization.

Like, content producer 102, certificate authority 106 can be implemented on any type of device, facility, and/or instrument of conversion that includes a processor and is capable of effective and/or operative communication with network topology and/or cloud 104. Illustrative mechanisms, machines, devices, facilities, and/or instruments that can comprise certificate authority 106 can include Tablet PCs, server class computing machines, laptop computers, notebook computers, desktop computers, cell phones, smart phones, consumer appliances and/or instrumentation, industrial devices and/or components, hand-held devices, personal digital assistants, multimedia Internet enabled phones, Global Positioning Systems (GPS), USB flash devices, multimedia players, televisions, and the like.

Web hosting server 108, in accordance with one aspect of the claimed subject matter, can distribute, broadcast, simulcast, and/or multicast content (e.g., audio and/or video multimedia content supplied by content producer 102). Web hosting server 108 on receipt of content and associated certificate from content producer 102 can parse the received certificate and retrieve the hash which it can then send to database engine 110. Web hosting server 108 can also verify authorship of content in order to deter and block dishonest content producers (e.g., content producers masquerading as legitimate content producers or content enhancers) and in such a manner avoid payment to these producers. Further, web hosting server 108 can facilitate or effectuate payment to content producer 102. Payment can be determined according to a prescribed and/or agreed formula (e.g., payment can be based at least in part on a proportion of downloads or viewership of content).

Web hosting server 108 can be implemented entirely in hardware and/or as a combination of software and/or hardware. Web hosting server 108 can be any type of machine that includes a processor and that is capable of effective communication with network topology and/or cloud 104. Illustrative machines that can comprise web hosting server 108 can include desktop computers, server class computing devices, cell phones, smart phones, laptop computers, notebook computers, Tablet PCs, consumer and/or industrial devices and/or appliances, hand-held devices, personal digital assistants, multimedia Internet enabled mobile phones, and the like. Additionally and/or alternatively, web hosting server 108 can include television or multimedia broadcast stations, and stations that broadcast, simulcast, and/or multicast audio and/or video multimedia content.

Database engine 110 and associated store 110_{A} can be a structured collection of records or data wherein the records or data is persisted in store 110_{A} and database engine 110 provides mechanisms and/or modalities to organize, structure and/or access the records and/or data associated or persisted in store 110_{A}. Additionally, database engine 110 in response to content producer 102's transmission of a hash obtained from the certificate delivered to content producer 102 by certificate authority 106 can send details associated with content producer 102 to web hosting server 108. Delivery of details associated with content producer 102 by database engine 110 to web hosting server 108 can be utilized to verify authorship or ownership of content as well as blocking dishonest producers or purported owner from illicitly benefiting from utilization of system 100.

Associated store 110_{A} can be local, remote, or distributed persistence media dispersed across network topology and/or cloud 104. Store 110_{A} can include any suitable data necessary for database engine 110 to facilitate it aims. For instance, store 110_{A} can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that store 110_{A} can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlinks DRAM (SLDRAM), Rambus® direct RAM (RDRAM), direct Rambus® dynamic RAM (DRDRAM) and Rambus® dynamic RAM (RDRAM). Store 110_{A} of the subject systems and methods is intended to comprise, without being limited to, these and any other suitable types of memory. In addition, it is to be appreciated that store 110_{A} can be a server, a database, a hard drive, and the like.

Client device 112 can be a device and/or component that plays back and/or records multimedia audio/visual content to or from associated storage media (e.g., volatile and/or nonvolatile memory that can be electronically erased and/or programmed, nonvolatile storage that persists digitally encoded data on rapidly rotating platters with magnetic and/or optically retentive surfaces and/or coatings, and/or magnetic tape). Client device 112 can download content or objects from web hosting server 108 for playback or further enhancement (e.g., splice or mix the downloaded into other downloaded content or objects). When client device 112 downloads content off of web hosting server 108, web hosting server 108 can deliver, or client device 112 can receive (e.g., web hosting server 108 can retrieve, or cause diverse other components to retrieve, disparate portions of the final downloaded “package” from disparate sources and thereafter can amalgamate the retrieved components to form the final downloadable “package”), content of interest as well as details associated with the content producer (e.g., content producer 102). Once client device 112 has successfully downloaded the content off of web hosting server 108, it can deliver the hashed content (e.g., a relatively short hashed representative of the content) to database engine 110. Client device 112 can also notify the content producer 102 of use of the downloaded content.

Client device 112 in addition can provide an instrumentality for a user to posit search queries for submission to database engine 110. Moreover, client device 112 can be a standalone set-top box, or portable recording and/or playback device. Additionally client device 112 can be implemented entirely in hardware and/or a combination of both hardware and/or software. Moreover, client device 112 can be incorporated within and/or associated with other compatible components. As will be appreciated client device 112 can be any type of mechanism, machine, device, facility, and/or instrument that includes a processor and is capable of effective and/or operative communication with network topology and/or cloud 104. Illustrative mechanisms, machines, devices, facilities, and/or instruments that can comprise client device 112 can include Tablet PCs, server class computing machines, laptop computers, notebook computers, desktop computers, cell phones, smart phones, consumer appliances and/or instrumentation, industrial devices and/or components, hand-held devices, personal digital assistants, multimedia Internet enabled phones, Global Positioning Systems (GPS), USB flash devices, multimedia players, televisions, and the like.

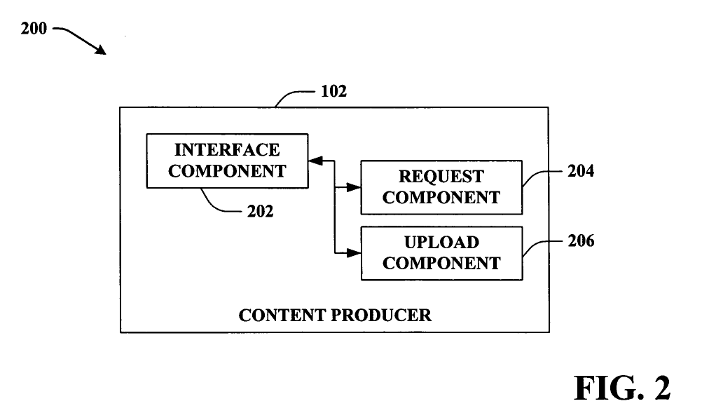

FIG. 2 provides illustration 200 of an illustrative content producer 102 that in accordance with an aspect of the claimed subject matter generates revenue or controls fraud by employing a media hash function. As illustrated, content producer 102 can produce content (e.g., multimedia content such as video, audio, images, and the like) or can be a consortium that includes major content-producers and/or technology companies that create and/or run a market-place. Content producer 102 can include interface component 202 (hereinafter referred to as “interface 202”) that can receive and/or distribute, communicate, and/or partake in data interchange with a plurality of disparate sources and/or components. For instance, interface 202 can receive and/or transmit data from, or to, a multitude of sources, such as, for example, data associated with certificate authority 106. Additionally and/or alternatively, interface 202 can obtain and/or receive data associated with usernames and/or passwords, sets of encryption and/or decryption keys, client applications, services, users, clients, devices, and/or entities involved with a particular transaction, portions of transactions, and thereafter can convey the received or otherwise acquired information to request component 204 and/or upload component 206, for subsequent and further utilization, processing, and/or analysis.

To facilitate its objectives, interface 202 can provide various adapters, connectors, channels, communication pathways, etc. to integrate the various components included in system 200, and more particularly, content producer 102, into virtually any operating system and/or database system and/or with one another. Additionally and/or alternatively, interface 202 can provide various adapters, connectors, channels, communication modalities, and the like, that can provide for interaction with the various components that can comprise system 200, and/or any other component (external and/or internal), data, and the like, associated with system 200.

Content producer 102 can include request component 204 that can direct content produced or enhanced by content producer 102 to certificate authority 106 and request certificate authority 106 to issue a certificate to be associated both with the directed content as well as with content producer 102. Generally, the certificate issued by certificate authority 106 can include a unique hash of the received contents together with details associated with content producer 102.

Once content producer 102 has received an appropriate certificate from certificate authority 106, it can employ upload component 206 to forward the content (e.g., un-hashed content) as well as the certificate associated with the content received from certificate authority 106 to web hosting server 108 for subsequent distribution or utilization by client device 112, for example.

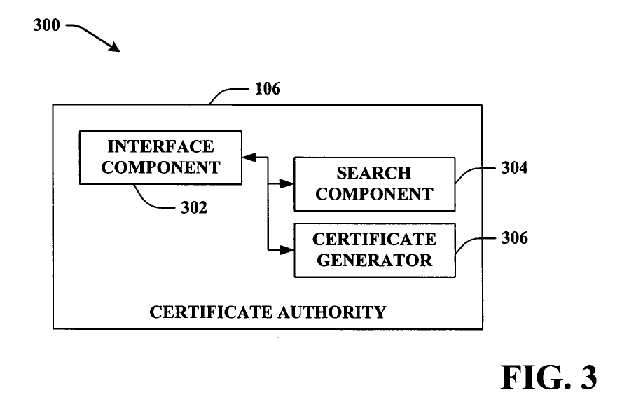

FIG. 3 provides depiction 300 of an illustrative certificate authority 106 that generates revenue or controls fraud by employing a media hash function in accordance with an aspect of the claimed subject matter. Certificate authority 106, in accordance with an illustrative instance of the claimed matter, can be a trusted entity and can further provide automatic dispute resolution since it typically agrees to create and issue certificates that contain a multimedia hash function that hashes an object or content into a short representation of the un-hashed content together with details associated with the producer of the object or content. Moreover, it should be noted that certificate authority 106 generally only issues and/or disseminated certificates associated with particular content where it is satisfied that, to its knowledge, there does not exist other objects or content encrypted with the same hash. Certificate authority 106

Certificate authority 106 can include interface component 302 the functionality of which is similar to that described in relation to interface 202 (see FIG. 2). Accordingly, because of the similarity of functionality and applicability of the two interface components (e.g., interface 202 and interface component 302), a detailed description of such features has been omitted to avoid needless repetition and for the sake of brevity and conciseness exposition.

Certificate authority 106 can include search component 304 that can effectuate a search of lists associating hashes of content objects with their respective producers, content enhances, etc. wherein the lists associating hashes of content objects are persisted on and/or associated with database engine 110 and confederate storage 110_{A}. Additionally and/or alternatively, search component 304, rather than itself effectuating the search of the lists associating hashes of content objects that are persisted on storage 110_{A} and associated with database engine 110, can cause database engine 110 to commence the search of storage media 110_{A}, thereby better employing the database engine's superior and more directed search capabilities.

Where search component 304 does not find an already issued certificate associated with other content or another object with a similar or the same hash, certificate authority 106 can employ certificate generator 306 to employ a media hash function to hash content received from content producer 102 in order to provide a relatively short hashed representation of the supplied content. Additionally, certificate generator 306 can also include with the generated certificate details associated with content producer 102 such as identifying attributes that can tie the issued certificate to a person, organization, server, etc. and/or that relate to producer of content.

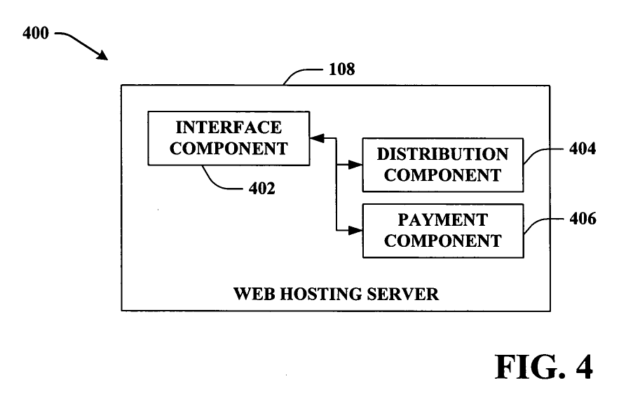

FIG. 4 provides illustration 400 of a web hosting server 108 that generates revenue or controls fraud by employing a media hash function in accordance with an aspect of the claimed subject matter. As illustrated web hosting server 108 can include interface component 402 that can have similar functionality as that described in relation to FIG. 2 and interface 202. Thus, since there exists a commonality of function and purpose between interface component 402 and interface 202 a detailed description of such features and/or functionality has been omitted to avoid needless repetition and for the sake of brevity and conciseness. Web hosting server 108 can include distribution component 404 that on receipt of content and associated certificate from content producer 102 can extract the hash (e.g., the relatively short hashed representation of the content generated by certificate authority 106). The extracted hash can then be sent to database engine 110 for subsequent utilization.

Additionally, web hosting component 108 can also include payment component 406 that facilitate payment to content producer 102 where legitimate use of content is made by client device 112. Payment to content producer 102 can be based at last in part on a prescribed and/or agreed formula. For example, payment to content producer 102 can be based at least in part on a proportion of downloads of content attributed to content producer 102.

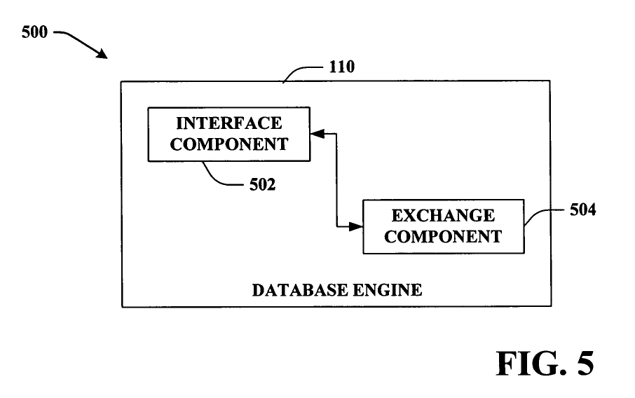

FIG. 5 provides illustration 500 of an aspect of a database engine 110 that generates revenue or controls fraud by employing a media hash function operable in accordance with an aspect of the claimed subject matter. Database engine 110 in accordance with an illustrative instance of the claimed matter and like certificate authority 102, can be a trusted entity. Database engine 110, together with associated persistence media or storage farms (e.g., store 110_{A}), can hold lists associating hashes of content objects with their producers, content enhancers, web-hosting services, etc. As depicted database engine 110 can include interface 502 that can operate in a similar manner to that describe in connection with interface 202. Accordingly, to avoid unnecessary repetition a detailed discussion of such functionality and/or applicability has been omitted for the sake of brevity.

Database engine 110 can include exchange component 504 that in response to the hash received from content producer 102 can transmit details associated with content provider 102 to web hosting server 108. Delivery of such detail can be employed to verify authorship or ownership of content as well as utilized to block dishonest producers or purported owners, enhancers, etc., from benefiting from illicitly obtained or purloined content.

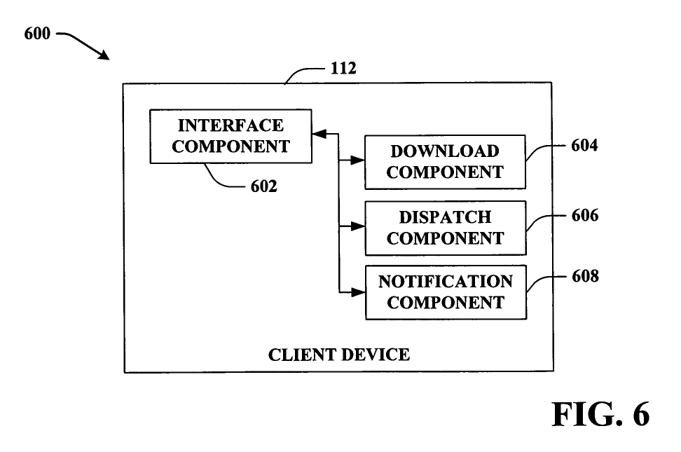

FIG. 6 provides depiction 600 of an illustrative client device 112 that generates revenue or controls fraud by employing a media hash function in accordance with an aspect of the claimed subject matter. In addition to interface component 602, discussion of which has been made with reference to FIG. 2 and interface component 202, client device 112 can include download component 604 that can download content or objects from web hosting server 108 for playback or further enhancement. When download component 604 retrieves content off of web hosting server 108, download component 604 can receive both the content of interest as well as details associated with the producer of the content (e.g., details associated with content producer 102).

Once download component 604 has retrieved content of interest off of web hosting server 108, dispatch component 606 can be utilized to deliver the hash (e.g., the relatively short hashed representation of the content obtained through utilization of a media hash function) to database engine 110, and notification component 608 can be employed to send notification to content producer 102 of the legitimate use of downloaded content.

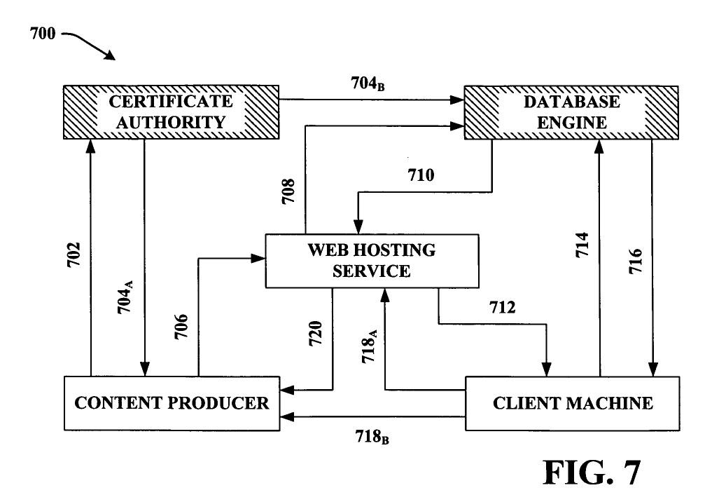

FIG. 7 depicts an illustrative transaction diagram 700, utilization of which generates revenue or controls fraud in accordance with an aspect of the claimed subject matter. As illustrated, transaction diagram 700 can commence at 702 where a content producer requests a certificate authority to issue a certificate for the content. As denoted by the shading of certificate authority and database engine respectively, these aspects of the claimed subject matter are typically to be considered trusted entities. At 704_{A} and 704_{B} the trusted certificate authority sends back to content producer and delivers to trusted database engine, a certificate that contains details associated with the content producer as well as a hash that represents a relatively short representation of the content. It should be noted that the hash delivered back to content producer as well as delivered to trusted database engine is typically not sensitive to minor or small deformation in its input. At 706 the content producer can transmit the content (e.g., un-hashed content) together with the issued certificate to web hosting service whereupon web hosting service can forward the hash included in the issued certificate to database engine at 708. At 710 the database engine can deliver details affiliated with the content producer associated with the earlier transmitted content. At 712 the web hosting service can deliver the content together with producer details associated with the content to a client machine. Typically, delivery of content to the client machine can be initiated by the client machine, though as will be appreciated the claimed subject is not necessarily so limited. At 714, once client machine has successfully received the downloaded or transmitted content and associated content producer details, the client machine can forward the hash that can represent a relatively short representation of the content to the database engine. At 716 the database engine can respond to receiving the hash from the client machine by transmitting content producer details, at which client machine at 718_{A} and 718_{B} can deliver notification of usage of the content to both the web hosting service and the content producer. At 720 the web hosting service can facilitate payment for utilization of the content to the associated content producer.

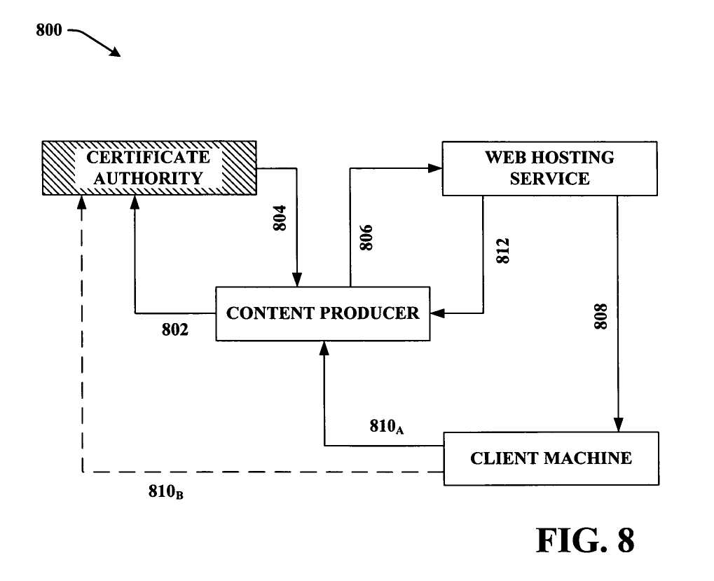

FIG. 8 provides an alternative or additional transaction flow diagram 800 that can be used to generate revenue or to control fraud in accordance with an aspect of the claimed subject matter. It should be noted that certificate authority in this illustration is considered to be a trusted entity and as such is for the purposes of exposition illustrated as being shaded. As depicted transaction diagram 800 can commence at 802 where content producer requests a trusted authority or certificate authority to provide or issue a certificate for the content. The trusted authority or certificate authority generally will only generate or provide a certificate if it can ensure that no other object has been previously hashed with the same or similar media hash (MH) function. For instance, the certificate authority or trusted authority can check a persisted dynamically extensible list of previously hashed content for collisions in order to determine whether or not another object has been previously hashed with the same or a similar media hash (MH) function and a secret key (x) persisted on or associated with the certificate authority or trusted authority. Where the trusted authority or certificate authority is able to ensure that no other object has been hashed using the same or a similar media hash (MH) function, the trusted authority or certificate authority can certify the content provided or supplied by the content producer in the earlier request. The certificate authority or trusted authority can thereafter generate and/or send a certificate back to the content producer at 804. Typically, the certificate generated and delivered to the content producer can include, in addition to hashed content and content producer details, information related to entities that have enhanced the content in anyway, entities that are authorized to enforce the certificate, time of issue of the certificate, expiration time of the certificate, duration for which the certificate is valid, entities that referred the content to the certificate authority or trusted authority for certification, and the like. Once the content producer has obtained a validly generated, issued, and/or distributed certificate the content producer can, at 806, upload the certificate as well as associated content to, for example, web hosting service (the web hosting service can possibly be malicious). On receipt of the certificate and associated content from the content producer, the web hosting service, at 808, can download, or permit client device or machine to retrieve, the content as well as the associated certificate for playback on the client machine or device. At 810_{A} the client device or machine can send notification to content producer that it has downloaded or retrieved content attributed to the content producer. Additionally and/or alternatively (e.g., depicted by the dashed directional flow), at 810_{B} client device or machine can dispatch notification of retrieval or usage of content to the certificate authority or trusted authority. At 812 the web hosting service can facilitate or effectuate payment for use of the downloaded or retrieved content associated with the content producer. It should be noted, without limitation or reservation, that given the prolixity and multitude of transactions that need transpire with regard to FIG. 7 in contrast to the brevity and paucity of transaction with respect to FIG. 8, that systems that adopt the transaction flow set forth in FIG. 8 are typically more secure and/or simpler to implement.

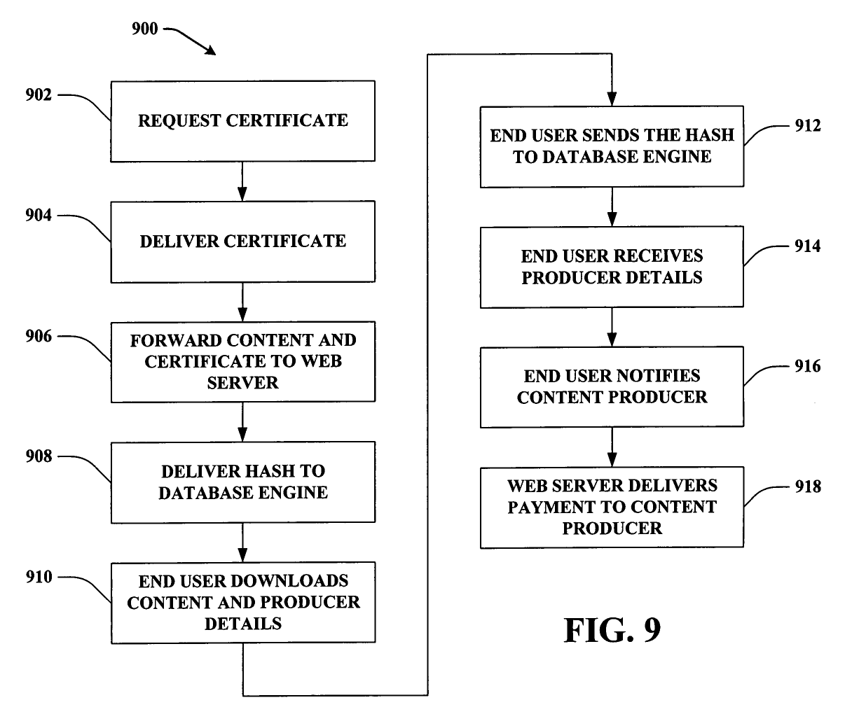

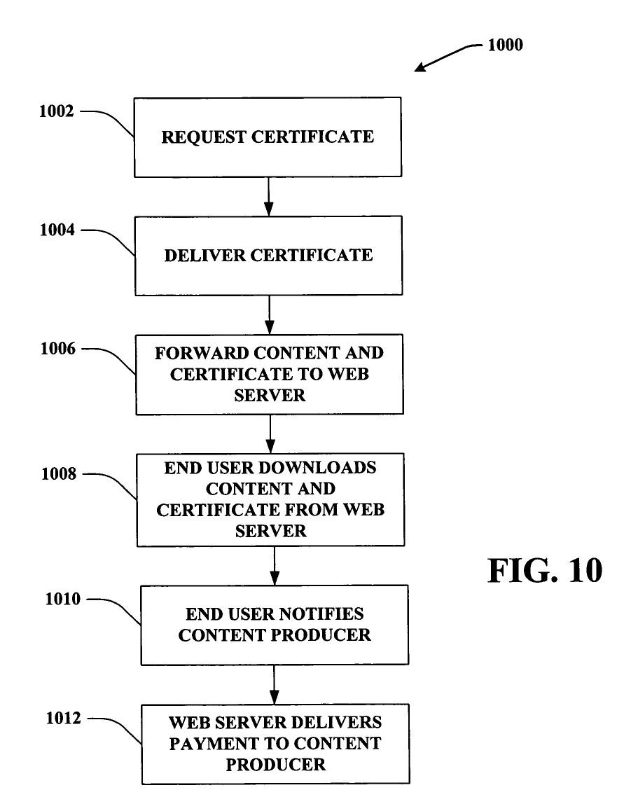

In view of the illustrative systems shown and described supra, methodologies that may be implemented in accordance with the disclosed subject matter will be better appreciated with reference to the flow chart of FIG. 9 and FIG. 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 9 illustrates a machine implemented methodology 900 that generates revenue or controls fraud in accordance with an aspect of the claimed subject mater. Method 900 can commence at 902 where a content producer can request that a certificate be issued for content. Content producer can send content together with the request to a certification authority. Certificate authority on receipt of the request can facilitate a search to determine whether other content or objects have been previously issued a certificate associated with the same hash. Where certificate authority determines that no certificate has been issued and/or associated with the same hash it can issue and deliver a certificate back to the requestor (e.g., content producer) at 904. At 906 content producer can forward content together with the issued certificate obtained from certificate authority to a web server or web service. At 908 web server or web service can deliver or transmit the hash included in the issued certificate to a database engine. At 910 an end user using client device 112, for instance, can download content off of the web server or web service. Typically, downloaded content can include produced content together with details associated with the producer of the content. At 912 once the client device 112 has successfully downloaded the produced content and associated producer details the end user through the facilities of client device 112 can send the hash to the database engine. At 914 the end user, once again through the facilities associated with client device 112 can receive details associated with the producer of the downloaded content. At 916 client device 112 on behalf of the user can notify the content producer as well as web service or server of usage of the downloaded content. At 918 on receipt of notification of usage of downloaded content, web server or web service can effectuate and/or facilitate payment to the content producer based at least in part on an agreed formulation.

FIG. 10 illustrates a machine implemented methodology 1000 that generates revenue or controls fraud in accordance with an aspect of the claimed subject mater. Methodology 1000 can commence at 1002 where a content provider can request that a certificate be generated and/or issued for supplied content. A trusted authority on receipt of the request and/or associated content can effectuate a search of various persisted lists for collisions to ensure that no other content or objects have previously been issued a certificate associated with the same or a similar hash. Where the trusted authority determines that no certificate has previously been generated, issued, and/or associated with the same hash, the trusted authority can create, issue, and/or dispatch a certificate to the content provider at 1004. At 1006 the content producer can forward the content and recently acquired and associated certificate to a web server or web hosting service. At 1008 an end user employing client device 112, for example, can download content together with associated certificates off of the web server, or from the web hosting service. At 1010 the end user through the facilities of client device 112, for instance, can notify the content producer that content affiliated with the content provider has been downloaded or utilized. Additionally and/or alternatively at 1010 the end user, once again through use of client device 112, can also notify the trusted authority of his or her retrieval and/or usage of content associated with content provider. At 1012 the web server or web hosting service can effectuated and/or facilitate payment to the content provider based at least in part on an agreed upon formulation.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantifies within the machine and/or computer system memories or registers or other such information storage, transmission and/or display devices.

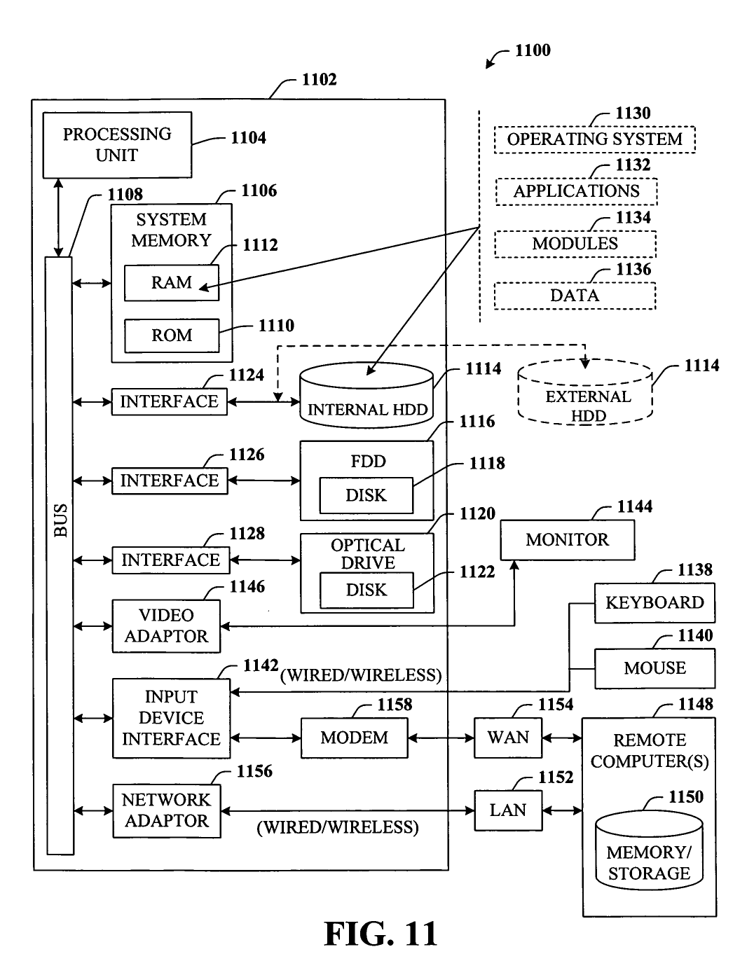

Referring now to FIG. 11, there is illustrated a block diagram of a computer operable to execute the disclosed system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the illustrative environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1094 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are illustrative and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

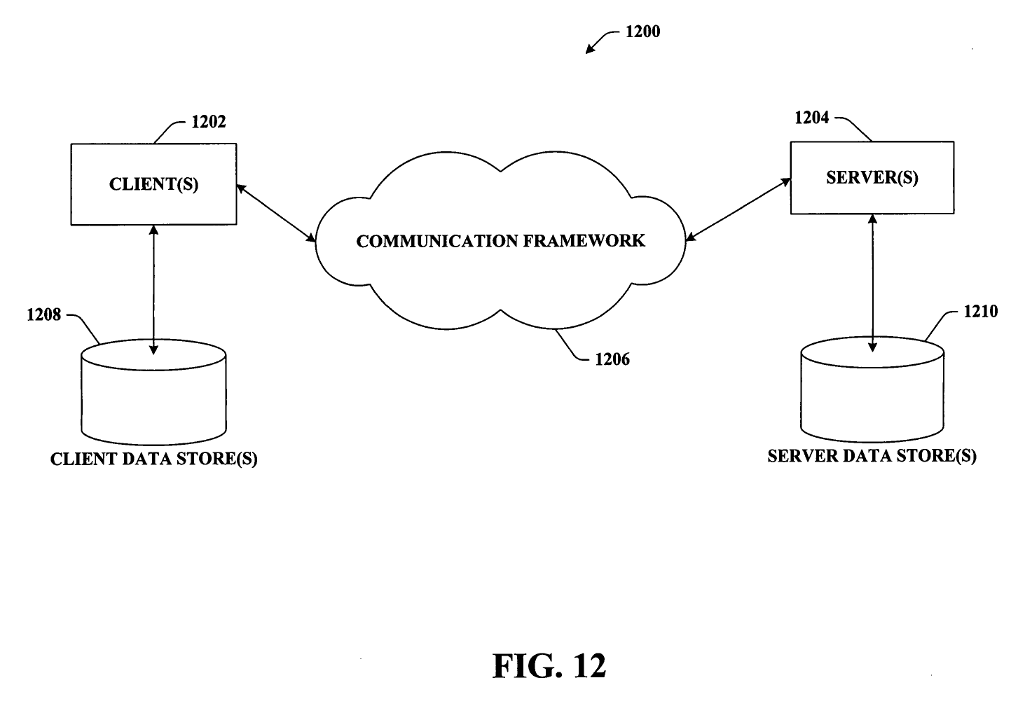

Referring now to FIG. 12, there is illustrated a schematic block diagram of an illustrative computing environment 1200 for processing the disclosed architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that at least one of controls fraud or generates revenue, comprising:
a component that uploads content via an interface to a generator that employs the content to produce a certificate that includes a short representation of the content, the component uploads the content together with the certificate to a server, at a request of a client device the server downloads the content to the client device, the client device notifies the component of the download of content to the client device and the server effectuates payment to the component for the download of the content to the client device.

2. The system of claim 1, the generator employs a media hashing function to produce the short representation of the content, the media hashing function insensitive to small variances associated with the content.

3. The system of claim 1, the generator causes a database engine to effectuate a search of storage associated with the database engine for the short representation of the content.

4. The system of claim 1, the certificate created by the generator when a search of storage associated with a database yields no results.

5. The system of claim 1, the generator forwards the certificate to a database engine for storage on a storage device associated with the database engine.

6. The system of claim 1, the certificate further includes the detail associated with the producer of the content.

7. The system of claim 1, at the request of the client device the server simultaneously downloads the detail associated with the producer of the content to the client device.

8. The system of claim 1, the server extracts the short representation of the content from the certificate delivered by the generator to the component.

9. A machine implement method that at least one of controls fraud or generates revenue, comprising:
utilizing uploaded content to produce a certificate that includes a short representation of the content;
delivering the content together with the certificate to a server;
directing the short representation of the content to a database engine;
supplying the server with a detail associated with a producer of the content;
requesting the server download the content to a client device;
informing the component of utilization of the content; and
facilitating payment for utilization of the content.

10. The method of claim 9, the utilizing further comprising using a media hash function to produce the short representation of the content, the media hash function insensitive to small deformations associated with the content.

11. The method of claim 9, the utilizing further comprising effectuating a search of storage associated with the database engine for the short representation of the content.

12. The method of claim 9, the utilizing further comprising generating the certificate when a search of storage associated with the database engine returns a null set.

13. The method of claim 9, further comprising storing the certificate on storage associated with the database engine.

14. The method of claim 9, the certificate includes the detail associated with the producer of the content.

15. The method of claim 9, the requesting further comprising contemporaneously downloading the detail associated with the producer of the content to the client device.

16. The method of claim 9, the directing further comprising obtaining the short representation of the content from the certificate.

17. A system that generates revenue or controls fraud, comprising:
means for generating a certificate that includes a short representation of uploaded content;
means for delivering the uploaded content together with the certificate to a means for serving data;
means for directing a short representation of the uploaded content to a means for searching and persisting data;
means for supplying the means for serving data with a detail associated with a producer of the uploaded content;
means for downloading the uploaded content to a means for playback; and
means for facilitating payment for utilization of the uploaded content.

18. The system of claim 17, the means for generating employs a media hash function to produce the short representation of the uploaded content, the media hash function insensitive to small deformations associated with the uploaded content

19. The system of claim 17, further comprising means for contemporaneously downloading the detail associated with the producer of the uploaded content to the means for playback.

20. The system of claim 17, further comprising persisting the certificate on the means for searching and persisting data.
